(19) United States
(12) Patent Application Publication
(10) Pub. No.: US 2023/0024948 A1
(43) Pub. Date: Jan. 26, 2023

(54) METHOD FOR PRODUCING METAL BOROHYDRIDE FROM METAL BORON OXIDE

(71) Applicant: H2FUEL-SYSTEMS B.V., Voorschoten (NL)

(72) Inventor: Gerardus Wilhelmus LUGTIGHEID, Spijkernisse (NL)

(21) Appl. No.: 17/782,442

(22) PCT Filed: Dec. 2, 2020
(86) PCT No.: PCT/NL2020/050750

§ 371 Date: Jun. 3, 2022

(30) Foreign Application Priority Data
Dec. 6, 2019 (NL) 2024400

(51) Int. Cl. C01B 6/17

(52) U.S. Cl. CPC C01B 6/17

(57) ABSTRACT

A method for producing metal borohydride, Me(BH₄)ₙ, from metal boron oxide, Me(BO₂)ₙ, in which Me is a metal or a molecule that shows metal-like behaviour and can act as a metal, and n is an integer number that can be associated with the valence of the metal, wherein in a first fluidized bed step the metal boron oxide is provided in a first fluidized bed. The first fluidized bed is fluidized using a gas selected from at least one of nitrogen, N₂, gas and a noble gas, optionally the noble gas being selected from at least one of helium, He; neon, Ne; argon, Ar; and xenon, Xe, under such circumstances, especially pressure and temperature, that oxygen atoms are removed from the metal boron oxide to provide metal boron, MeBn, particles, possibly ions. In a subsequent second fluidized bed step the metal boron particles are provided in a second fluidized bed that is fluidized using hydrogen, H₂, gas under such circumstances that hydrogen chemically reacts with the metal boron particles to provide metal borohydride.

### FIELD OF THE INVENTION

The invention relates to a method producing metal borohydride from metal boron oxide (metal boron oxide). The invention further relates to an apparatus for carrying out such method.

### BACKGROUND OF THE INVENTION

Hydrogen (H₂) is widely recognized as one of the most promising energy sources of the future due to its high energy density and to its considerable abundance and availability in nature. In addition, H₂ is rightly regarded as one of the cleanest fuels, in that the only waste produced after its use is water.

However, despite the extensive technological efforts of the past decades, costs involved in the production, storage and transportation of H₂ are still considerable and prevent a widespread use of H₂ as a fuel. This is particularly true when hydrogen is used in a gaseous form which, due to is very low specific weight, implies additional costs for a continuous cooling or compression of H₂ in a container suitable for storing such a highly reactive element.

In view of this, promising methods and systems of storing hydrogen using a metal borohydride, Me(BH₄)ₙ, from which H₂ can be released with hydrolysis, have been recently developed.

In the reaction of the metal borohydride, Me(BH₄)ₙ, with water, a number of reaction products, like Me(BO₂)ₙ and possibly MeClₙ, can be produced into a spent fuel mixture, which may also comprise other compounds of the metal, boron and oxygen. Some of these reaction products may be recycled again. However, the known processes for the regeneration to a metal borohydride, Me(BH₄)ₙ, starting from a spent fuel mixture are still quite inefficient in the energy required and in the reconversion rate from the spent fuel to metal borohydride.

### SUMMARY OF THE INVENTION

It is an objective of the invention to provide an efficient method for reconverting the products of the hydrolysis of metal borohydride into metal borohydride.

It is another or an alternative objective of the invention to provide an efficient method for reconverting the products of the hydrolysis of metal borohydride into metal borohydride using at least one fluidized bed.

It is another or an alternative objective of the invention to provide an efficient method for transforming a metal boron oxide into a metal borohydride using at least one fluidized bed.

It is another or an alternative objective of the invention to provide an efficient method for transforming a solid metal boron oxide in a fluidized bed into a metal borohydride.

It is another or an alternative objective of the invention to provide an efficient method for transforming a solute metal boron oxide dissolved in a fluidized bed into a metal borohydride.

It is another or alternative objective of the invention to provide a waste-free method for converting a metal boron oxide to a metal borohydride.

It is yet another or alternative objective of the invention to provide a method for storing H₂ in the form of a metal borohydride starting from the products of the hydrolysis of metal borohydride.

It is yet another or an alternative objective of the invention to provide a method for efficiently recycling spent fuel, in case metal borohydride and water are used as a fuel for the extraction of hydrogen.

It is yet another or alternative objective of the invention to provide a method for efficiently providing products of the hydrolysis of metal borohydride into metal boron oxide, which can be used for further conversion into metal borohydride.

At least one of these objectives is achieved by a method for producing metal borohydride, Me(BH₄)ₙ, from metal boron oxide, Me(BO₂)ₙ, in which Me is a metal or a molecule that shows metal-like behaviour and can act as a metal, and n is an integer number that is associated with the valence of the metal, wherein
in a first fluidized bed step the metal boron oxide is provided in a first fluidized bed that is fluidized using a gas selected from at least one of nitrogen, N₂, gas and a noble gas, optionally the noble gas being selected from at least one of helium, He; neon, Ne; argon, Ar; and xenon, Xe, under such circumstances, especially pressure and temperature, that oxygen atoms are removed from the metal boron oxide to provide metal boron, MeBₙ, particles, possibly ions; and
in a subsequent second fluidized bed step the metal boron particles are provided in a second fluidized bed that is fluidized using hydrogen, H₂, gas under such circumstances that hydrogen chemically reacts with the metal boron particles to provide metal borohydride.

In an embodiment, the metal boron oxide is provided in the first fluidized bed step (B1) in the first fluidized bed in a state in which the metal boron oxide is dissolved in a suitable first liquid, optionally comprising water, optionally comprising water provided by reverse osmosis, optionally comprising ultrapure water, UPW.

In an embodiment, the water satisfies at least one of having an electrical conductance below 1 μS/cm, optionally below 0.5 μS/cm, optionally below 0.1 μS/cm, optionally below 0.06 μS/cm, optionally at 0.056 μS/cm or below, and optionally having an ASTM Electronics and Semiconductor Grade Water Type E-1 classification or better.

In an embodiment, the metal boron oxide is provided in the first fluidized bed step in the first fluidized bed in a state in which the metal boron oxide is provided in a solid form in a suitable second liquid, optionally ethanol, optionally the metal boron oxide being dried first before providing in the suitable second liquid.

In an embodiment, oxygen, O₂, gas formed from a chemical reaction of two oxygen atoms removed from the metal boron oxide is separated out of the first fluidized bed in the first fluidized step using a suitable membrane.

In an embodiment, the metal boron, MeBₙ, particles are provided in the second fluidized bed step in the second fluidized bed in a state in which the metal boron particles are dissolved in a suitable third liquid, optionally comprising toluene.

In an embodiment, the metal boron, MeBₙ, particles are provided in the second fluidized bed step in the second fluidized bed in a state in which the metal boron particles are in a solid form in a suitable fourth liquid, optionally comprising di-ethylene.

In an embodiment, in the first fluidized bed step a temperature of the first fluidized bed is less than a maximum temperature at which a bond of MeB would be broken in order to keep the bond of MeB intact

In an embodiment, comprising a recycling process of a recycling mixture of compounds of the metal, boron and oxygen to yield metal boron oxide, Me(BO₂)ₙ, to be provided in the first fluidized bed step.

In an embodiment, the recycling process comprises a recycling method as referred to below.

In another aspect the invention provides for a recycling method for producing metal boron oxide, Me(BO₂)ₙ, in which Me is a metal or a molecule that shows metal-like behaviour and can act as a metal, and n is an integer number that is associated with the valence of the metal, from a recycling mixture of metal chloride, Me(Cl)ₙ, and of compounds comprising the metal, boron and oxide, wherein the metal chloride is separated from the mixture, and metal hydroxide, MeOH, is provided to the mixture to chemically react with the compounds to yield metal boron oxide.

In an embodiment, the compounds comprise metal tetraborate.

In an embodiment, metal chloride is separated from the mixture by employing centrifugal forces.

In an embodiment, the separated metal chloride is mixed with water, optionally water provided by reverse osmosis, optionally ultrapure water, UPW, and the aqueous mixture of metal chloride is subjected to an electrolysis step € to yield metal hydroxide, MeOH, and clorine atoms, after which the chlorine atoms are further allowed to chemically react with water to form hydrogen chloride, HCl.

In an embodiment, metal hydroxide from the electrolysis step is provided to the recycling mixture.

In an embodiment, the water satisfies at least one of having an electrical conductance below 1 μS/cm, optionally below 0.5 μS/cm, optionally below 0.1 μS/cm, optionally below 0.06 μS/cm, optionally at 0.056 μS/cm or below, and optionally having an ASTM Electronics and Semiconductor Grade Water Type E-1 classification or better.

In an embodiment, the hydrogen chloride is allowed to escape as hydrogen chloride gas that is drawn off.

In an embodiment, the recycling mixture is heated to convert compounds comprising the metal, boron and oxide, especially metal tetraborate, to metal boron oxide.

In embodiments, the metal is selected from at least one of sodium, Na; potassium, K; Lithium, Li; and magnesium, Mg.

In yet another aspect the invention provides for an apparatus adapted for carrying out a method as referred to above.

### BRIEF DESCRIPTION OF THE DRAWINGS

Further features and advantages of the invention will become apparent from the description of the invention by way of non-limiting and non-exclusive embodiments. These embodiments are not to be construed as limiting the scope of protection. The person skilled in the art will realize that other alternatives and equivalent embodiments of the invention can be conceived and reduced to practice without departing from the scope of the present invention. Embodiments of the invention will be described with reference to the accompanying drawings, in which like or same reference symbols denote like, same or corresponding parts, and in which

FIG. 1 shows a schematic overview of a method according to an embodiment of the invention for producing a metal borohydride; and

FIG. 2 shows a schematic overview of a method according to another embodiment of the invention for producing a metal boron oxide.

### DETAILED DESCRIPTION OF EMBODIMENTS

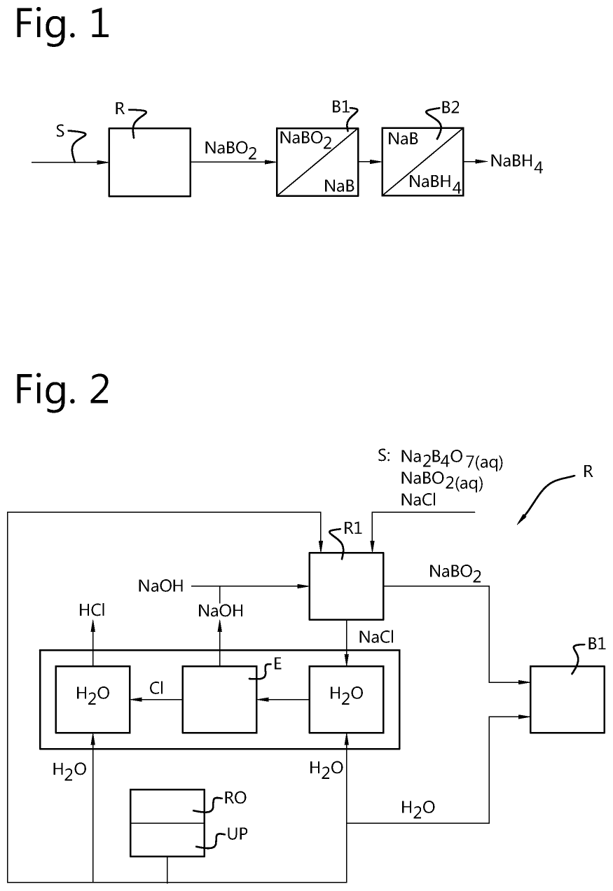

A schematic representation of an embodiment of the method of the invention is shown in FIG. 1. A spent fuel, generally in a wet form, comprising a metal boron oxide, Me(BO₂)ₙ, and possibly a metal chloride, MeClₙ, is transformed to a metal borohydride, Me(BH₄)ₙ, by making use of two fluidized beds in two different steps of the process. The energy needed in the fluidized bed processes is inter alia provided as pressure and/or heat. The metal includes any material generally referred to as a metal, including alkali metals, alkali earth metals, transition metals and complex metals. The process below is further mainly described with reference to sodium as the metal, but other metals, such as, inter alia, potassium, K; Lithium, Li; and magnesium, Mg; or any molecule that can show metal like behaviour and act as a metal can be employed as well. The metal of metal-like acting molecule acts as a carrier for the groups BO₂, B, BH₄, B₄O₇, etcetera. A spent fuel S generally refers to a mixture of compounds that results from reaction processes converting a metal borohydride to yield hydrogen, H₂, gas, which may be used in a fuel cell for generation of electrical energy. The conversion of metal borohydride can yield a spent fuel mixture of various compounds depending on the actual circumstances driving the conversion. Such conversion may be driven by a catalyst and/or by an acid. In the latter case, the spent fuel S may comprise a metal chloride when, for instance, hydrogen chloride has been employed as a reaction accelerating acid.

In the process shown in FIG. 1, an aqueous mixture, referred to as spent fuel S, of, for instance, borax, Na₂B₄O₇(aq); sodium boron oxide, NaBO₂(aq), and sodium chloride, NaCl is, in a recycle process R converted to sodium boron oxide, NaBO₂. The sodium boron oxide (sodium metaborate) can be in a hydrate form, generically written as NaBO₂·xH₂O. An embodiment of a recycle process R is described below with reference to FIG. 2.

In a first fluidized bed step B1, a first fluidized bed is provided which consists of a suitable fluid at a predetermined pressure and heated up to a predetermined temperature to which a noble gas or molecular nitrogen, N₂, gas are added. The noble gas or the molecular nitrogen introduced in the first fluidized bed act as impinging elements to promote the release of oxygen atoms from the sodium boron oxide, NaBO₂, provided to the first fluidized bed.

In an embodiment of the invention the sodium boron oxide is provided as a solid, for instance, as one of its hydrates, to the first fluidized bed in a suitable fluid. In this case, the liquid of which the first fluidized bed is composed is ethanol, C₂H₆O. In another embodiment of the invention, NaBO₂ is provided as a concentrated liquid to the first fluidized bed. In this case, the liquid of which the first fluidized bed is composed is ultra-pure water, UPW. UPW can be defined as satisfying at least one of having an electrical conductance below 1 μS/cm, optionally below 0.5 μS/cm, optionally below 0.1 μS/cm, optionally below 0.06 μS/cm, optionally at 0.056 μS/cm or below, and optionally having an Electronics and Semiconductor Grade Water ASTM Type E-1 classification or better. The water can be supplied by a reverse osmosis process. An advantage of providing the metal boron oxide, Me(BO₂)ₙ, as a concentrated liquid could be that the bond energies between the oxygen atoms and the boron atom are smaller than in the case Me(B02)ₙ is provided as a solid. Therefore, less energy would be required for the release of the oxygen atoms from the metal boron oxide Me(BO₂)ₙ when it is provided as a concentrated liquid.

In an embodiment of the invention, the noble gas present in the first fluidized bed has a mass larger than the mass of the oxygen. In this case, krypton, Kr, or xenon, Xe, can be used. In view of the difference of mass and size between the atoms of these heavier noble gasses and the oxygen atoms, the dissociation of the oxygen atoms from the metal boron oxide is facilitated. In another embodiment of the invention, the noble gas present in the first fluidized bed is argon, Ar. The advantage of using Ar in the first fluidized bed is due to the fact that Ar is the less expensive of the noble gasses and has a mass close to the mass of oxygen. This makes Ar a very suitable element that can be used to promote the dissociation of oxygen from the metal boron oxide. The skilled person will understand that any noble gas may be used in the above-described process and that this invention is not limited to the examples above. In case of the metal being sodium, a temperature of the first fluidized bed in the first fluidized bed step B1 is less than a maximum temperature at which the NaB bond would be broken, in order to keep the bond in NaB, or the MeB bond in general, intact.

After promoting the dissociation of oxygen atoms from the metal boron oxide, the noble gas or the nitrogen gas may leave the fluidized bed. Such emitted elements can be subsequently trapped and stored and then reintroduced into the process. The removed oxygen atom will react into oxygen molecules. Membrane filters are employed for separating the oxygen gas, and possibly other gasses as well, from the fluidized bed.

The remaining MeBₙ group, NaB in the FIG. 1 embodiment, produced in the first fluidized bed step B1 after the removal of oxygen is separated in the first fluidized bed from the free oxygen. The separation between the noble gas or nitrogen atoms and the oxygen atoms remaining in the first fluidized bed is facilitated when heavier noble gasses are used, due to the considerable difference in mass and size between such noble gas atoms and the oxygen atoms or molecules.

In a next, second fluidized bed step B2 of the process, the produced group MeBₙ is provided to a second fluidized bed. The second fluidized bed consists of a suitable fluid at a predetermined pressure and at a predetermined temperature, to which molecular hydrogen, H₂, is added. The molecular hydrogen reacts with the MeBₙ to produce a metal borohydride, Me(BH₄)ₙ.

In an embodiment of the invention, the group MeBn is provided in a dissolved liquid phase to the second fluidized bed. In this case, the liquid of which the second fluidized bed is composed may be di-ethylene. In another embodiment of the invention, MeBₙ is provided as a solid to the second fluidized bed. In this case, the liquid of which the second fluidized bed is composed may be toluene.

The MeBₙ circulates in the second fluidized bed while hydrogen is delivered in bubbles under the influence of pressure and temperature. At the end of this step, Me(BH₄)ₙ is produced by means of the reaction of the hydrogen reacting with the MeBn provided to the second fluidized bed.

In this overall process, all the liquids used in the first and second fluidized beds and all the added gasses and elements can be re-used in a subsequent processes. For these reasons, such processes may be considered as being waste-free, in that no pollutants nor waste are created.

As shown as an embodiment in FIG. 2, a spent fuel S of Na₂B₄O_{7(aq)} (sodium tetraborate), NaBO₂ and NaCl in a wet form is supplied to first recycling process steps R1. The metal chloride is separated from the spent fuel (recycling mixture) by a separation process, such as one employing centrifugal forces. The separated metal chloride is dissolved in water, H₂O, and an electrolysis E is carried out on such a solution. This electrolysis produces metal hydroxide, being NaOH in the embodiment disclosed, and chlorine atoms.

The metal hydroxide is provided to the recycling mixture (spent fuel mixture) to allow chemical reaction (conversion) of the sodium tetraborate to sodium boron oxide, while heating the recycling mixture to promote the chemical reaction. Metal hydroxide has also been supplied separately to the recycling mixture to start the process. The chlorine atoms in the aqueous solution after the electrolysis E further react with water to yield hydrogen chloride, HCl, which is allowed to escape from the solution and is drawn off. The hydrogen chloride can be used again as an acidic promotor for driving a conversion reaction of metal borohydride to hydrogen. FIG. 2 shows dissolving of sodium chloride in water, the electrolysis process E, and reaction of chlorine atom with water as three reaction block, but are actually occurring in one process environment.

Sodium boron oxide from recycling process steps R1 is supplied to further process steps to provide sodium borohydride. In the FIG. 2 embodiment, the sodium boron oxide is provided to the first fluidized bed step B1 of the FIG. 1 embodiment. The water used in the various process steps shown in FIG. 2, and also in FIG. 1, is provided by a reverse osmosis process RO, and especially is ultrapure water, UPW, provided in an ultra-purification process UP after the RO process. The water satisfies at least one of having an electrical conductance below 1 μS/cm, optionally below 0.5 μS/cm, optionally below 0.1 μS/cm, optionally below 0.06 μS/cm, optionally at 0.056 μS/cm or below, and optionally having an ASTM Electronics and Semiconductor Grade Water Type E-1 classification or better.

The methods disclosed generally apply to a method to process any metal boron oxide into the associated metal borohydride. In an embodiment, the metal to be used in the process may be sodium, Na, as a metal in view of its abundance and they high values of free energy of its compounds. The basic values for the Gibbs energies and the molar masses of the elements participating in the recycling process when the metal used in sodium are as shown in the table below.

| | Gibbs energy | Molar mass | Gibbs energy |
|---|---|---|---|
| | [kJ/mole] | [g/mole] | [kJ/kg] |
| NaOH** | −379.5 | 40.0 | −9,488.0 |
| NaBO₂*** | −906.5 | 65.08 | −13,776.6 |
| NaBH₄** | −123.9 | 37.8 | −3,275.9 |

*https://en.wikipedia.org/wiki/List_of_standard_Gibbs_free_energies_of_formation
**Handbook of Chemistry and Physics, 76^{th} edition
***www.citrination.com

If sodium, Na, is the metal involved in the process, the spent fuel can comprise borax, Na₂B₄O₇, which can be easily converted into the metal boron oxide, NaBO₂, by providing energy in the form of temperature to the spent fuel.

1. A method for producing metal borohydride, Me(BH₄)ₙ, from metal boron oxide, Me(BO₂)ₙ, in which Me is a metal or a molecule that shows metal-like behaviour and can act as a metal, and n is an integer number that is associated with the valence of the metal, wherein
in a first fluidized bed step the metal boron oxide is provided in a first fluidized bed that is fluidized using a gas selected from at least one of nitrogen, N₂, gas and a noble gas, under such circumstances, especially pressure and temperature, that oxygen atoms are removed from the metal boron oxide to provide metal boron, MeBₙ, particles, possibly ions; and
in a subsequent second fluidized bed step the metal boron particles are provided in a second fluidized bed that is fluidized using hydrogen, H₂, gas under such circumstances that hydrogen chemically reacts with the metal boron particles to provide metal borohydride.

2. The method according to claim 1, wherein the metal boron oxide is provided in the first fluidized bed step in the first fluidized bed in a state in which the metal boron oxide is dissolved in a suitable first liquid.

3. The method according to claim 2, wherein the suitable first liquid comprises water, and the water satisfies at least one of having an electrical conductance below 1 μS/cm or having an ASTM Electronics and Semiconductor Grade Water Type E-1 classification or better.

4. The method according to claim 1, wherein the metal boron oxide is provided in the first fluidized bed step (B1) in the first fluidized bed in a state in which the metal boron oxide is provided in a solid form in a suitable second liquid.

5. The method according to claim 1, wherein oxygen, O₂, gas formed from a chemical reaction of two oxygen atoms removed from the metal boron oxide is separated out of the first fluidized bed in the first fluidized step using a suitable membrane.

6. The method according to claim 1, wherein the metal boron, MeBₙ, particles are provided in the second fluidized bed step in the second fluidized bed in a state in which the metal boron particles are dissolved in a suitable third liquid.

7. The method according to claim 1, wherein the metal boron, MeBₙ, particles are provided in the second fluidized bed step in the second fluidized bed in a state in which the metal boron particles are in a solid form in a suitable fourth liquid.

8. The method according to claim 1, wherein in the first fluidized bed step a temperature of the first fluidized bed is less than a maximum temperature at which a bond of MeB would be broken in order to keep the bond of MeB intact

9. The method according to claim 1, and comprising a recycling process of a recycling mixture of compounds of the metal, boron and oxygen to yield metal boron oxide, Me(BO₂)ₙ, to be provided in the first fluidized bed step.

10. The method according to claim 9, wherein the recycling process comprises a recycling method for producing metal boron oxide, Me(BO₂)ₙ, in which Me is a metal or a molecule that shows metal-like behaviour and can act as a metal, and n is an integer number that is associated with the valence of the metal, from a recycling mixture of metal chloride, Me(Cl)ₙ, and of compounds comprising the metal, boron and oxide, wherein the metal chloride is separated from the mixture, and metal hydroxide, MeOH, is provided to the mixture to chemically react with the compounds to yield metal boron oxide.

11. A recycling method for producing metal boron oxide, Me(BO₂)ₙ, in which Me is a metal or a molecule that shows metal-like behaviour and can act as a metal, and n is an integer number that is associated with the valence of the metal, from a recycling mixture of metal chloride, Me(Cl)ₙ, and of compounds comprising the metal, boron and oxide, wherein the metal chloride is separated from the mixture, and metal hydroxide, MeOH, is provided to the mixture to chemically react with the compounds to yield metal boron oxide.

12. The method according to claim 11, wherein the compounds comprise metal tetraborate.

13. The method according to claim 11, wherein metal chloride is separated from the mixture by employing centrifugal forces.

14. The method according to claim 11, wherein the separated metal chloride is mixed with water, and the aqueous mixture of metal chloride is subjected to an electrolysis step € to yield metal hydroxide, MeOH, and clorine atoms, after which the chlorine atoms are further allowed to chemically react with water to form hydrogen chloride, HCl.

15. The method according to claim 14, wherein metal hydroxide from the electrolysis step is provided to the recycling mixture.

16. The method according to claim 14, wherein the water satisfies at least one of having an electrical conductance below 1 μS/cm, or having an ASTM Electronics and Semiconductor Grade Water Type E-1 classification or better.

17. The method according to claim 14, wherein the hydrogen chloride is allowed to escape as hydrogen chloride gas that is drawn off.

18. The method according to claim 14, wherein the recycling mixture is heated to convert compounds comprising the metal, boron and oxide, especially metal tetraborate, to metal boron oxide.

19. The method according to claim 1, wherein the metal is selected from at least one of sodium, Na; potassium, K; Lithium, Li; and magnesium, Mg.

20. An apparatus adapted for carrying out the method according to claim 1.
